(19) United States
(12) Patent Application Publication
(10) Pub. No.: US 2002/0124101 A1
(43) Pub. Date: Sep. 5, 2002

(54) Server-side optimization of content delivery to clients by selective in-advance delivery

(76) Inventor: Thomas Schaeck, Achern (DE)

Correspondence Address: Ronald L. Drumheller, Esq., 94 Teakettle Spout Road, Mahopac, NY, 10541, US

(21) Appl. No.: 09/933,144

(22) Filed: Aug. 20, 2001

(30) Foreign Application Priority Data
Aug. 18, 2000 (EP) 00117785.6

(51) Int. Cl. G06F 15/16

(52) U.S. Cl. 709/232; 709/219

(57) ABSTRACT

The present invention relates to network traffic improvements and proposes a mechanism for server-side performance optimization which is based on conditional in-advance content delivery to browsers associated with content requesting end-users, whereby the condition is determined preferably by evaluating the current load of the content server. One or a pair of dedicated server computer systems may contribute to that.

### 1. BACKGROUND OF THE INVENTION

1.1 Field of the Invention

The present invention relates to network traffic improvements. In particular, it relates to method and system for communicating site-oriented contents.

1.2 Related Art

Basically, the subject matter of the present invention is applicable to network traffic in a broad variety of situations, in particular, whenever an application requests data from any kind of server computer via a network. In particular data communication via the Internet and the world-wide-net is preferably addressed and is taken as an example for well applying the present invention's concepts. The term ‘site-oriented contents’, however shall not be understood as limited to the currently up-to-date websites only. Instead, it should be understood as comprising any information content which is presented piecewise to the end-user, and which has some delimited information content definition.

Network computing is an important sector of information technology. The increasing acceptance of the Internet during the last years increased the network traffic even more.

Today, web servers deliver content to browsers by analyzing the browser's request, retrieving data depending on that request from disk, databases or other sources associated to and managed by a server computer, rendering the content in a particular markup language like HTML, WML and sending the result page to the browser. The content that is delivered back to the browser satisfies the request sent by the browser, no matter whether a server has free processing capacity or is under high load at the time of the request.

In particular, the load of server computers due to the varying frequency of said requests has large peaks: under high load a requesting user must thus wait long time until he can receive the response to his request.

1.3 Objects of the Invention

It is thus an object of the present invention to provide a method and system which help to shorten the response time for the person associated with the requesting computer system.

### 2. SUMMARY OF THE INVENTION

These objects of the invention are achieved by the features stated in enclosed independent claims. Further advantageous arrangements and embodiments of the invention are set forth in the respective subclaims.

The present invention proposes a mechanism for server-side performance optimization abbreviated herein as SSPO which is based on conditional in-advance content delivery to browsers, wherby the condition is determined preferably by the current load of the content server(s). The present invention allows to avoid or at least to flatten extreme peaks in server load by using times of lower load to deliver content in advance:

For each incoming request, the server returns the requested content. Additional content is returned in advance depending on the current load of the server. The content to be returned in advance is determined by using estimated probabilities regarding the probability for an average user to select a specific, next content from the requested page, for example. If the server is under a high load, however, only the explicitly required content is transferred.

The mechanism can be implemented transparently for client and web server in the form of a gateway that supports in-advance delivery of content and consists of a client and a server part, which co-operate.

The present invention is based on the knowledge that processing time of the server is wasted during time spans with few incoming requests and small load. In prior art, even if the server is almost idle, it just handles the incoming request, although there is free processing capacity to do something else, and in particular to predict future requests and deliver content in advance. By that inventional feature of conditional, speculative in-advance delivery traffic situations are avoided in which requests that could have been predicted and satisfied in advance arrive at the server at a later point in time, when the load on the server is actually high.

The load-dependent in-advance content is preferably delivered as follows:

Whenever the server receives a request, it checks its load, e.g. using figures like the number of queued requests or processor utilization from a respective measurement.

If the load exceeds a certain limit, no content will be delivered in advance, the server only delivers the content explicitly requested by the client.

If the load is below a certain limit, the server can afford to deliver some content in advance. The amount of content delivered in advance is proposed to depend on the current load: the smaller the load, the more content can be delivered in advance. However, a constant amount, for example, one additional page is possibly easier to implement and already quite efficient in regard of possible mispredictions due to the semantic dependencies in the tree-hierarchy or in the at least strongly branched graph structure of websites including meshes created by direct cross-links.

The selection of content for in-advance delivery according to a preferred aspect of the present invention is summarized as follows:

Web Sites can be represented as graphs, where the nodes are pages and the vertices are links. In such a graph, a weight can be assigned to each vertex the particular value of which expresses the estimated probability for a user-initiated selection of a respective link. The current page represents the start node of the vertex, wheras the target node is the page where the link points to. If a particular page is requested by the client, the server identifies at least one successor of the associated node with the (respective) highest estimated selection probability. Then, the one or more pages associated with the identified successors are delivered in advance, together with the requested page.

According to a further preferred aspect of the present invention a particular gateway mechnism is proposed for increasing the flexibility for using the present invention. This is referred to herein as SSPO gateway for in-advance delivery:

Today's browsers and servers do not support server-side in-advance delivery of content. However, a gateway can be set up to provide in-advance delivery anyway. In an inventional web scenario, said gateway consists of an SSPO Client (proxy) on the client side and an intermediate SSPO server on the server side.

The WebBrowser is configured to use the SSPO Client as a proxy server. Each request the SSPO Client receives is served from the cache or forwarded to the SSPO Server. The SSPO Server receives requests from the SSPO Client and forwards these requests to the appropriate web server. Depending on the current load, the SSPO server may also send some additional requests to the web server to retreive content to be sent to the client in advance along with the content explicitly requested. The SSPO client receives the requested content along with the content served by the SSPO Server in advance. The content that relates to the original request from the web browser is sent to the browser, while the content that was sent by the SSPO server is stored in the local cache for later use.

In a particular situation in which a client uses a WML-compliant Browser tool and WML is used for describing the transferred contents the client computer itself can advantageously take profit from the capability of WML to transport more than one page in a deck such that the advantage arises that in these cases no SSPO client is needed anymore.

According to a further preferred feature of the present unvention receiving transmission time information associated to particular requests, can be transmitted back to the web server. Said server tracks said information with the respective transmission and some simple algorithm can be implemented which evaluates it as a feedback information for controlling the amount of additional content, i.e., in order to delimit, to increase or decrease the delivered amounts of additional content. If it turns out, for example, that a particular transmission time is quite long, although the source web server stands under a small load it can be concluded that there is some bottleneck somewhere else along the transmission path actually in use. Thus, respective measures may be undertaken to increase the transmission rate as e.g., to route along a different path, or, if this is not feasible, to delimit the amount of additional content delivered to a reasonable degree. This helps to avoid non-controllable and unforeseeable increase of network traffic when the present invention is very broadly implemented, for example in a majority of end-user computers being requesters of the network traffic.

### 3. BRIEF DESCRIPTION OF THE DRAWINGS

The present invention is illustrated by way of example and is not limited by the shape of the figures of the accompanying drawings in which:

FIG. 1 is a schematic representation illustrating an example of a part of a book seller web site where in-advance delivery can be used,

FIG. 2 is a schematic representation illustrating the load generated on the server and communication between client and server during a dialog for buying a book. Left without in-advance delivery of content, right with in-advance delivery, with time direction down,

FIG. 3 is a schematic representation illustrating the implementation in a servlet for WAP content, in which the servlet performs in-advance delivery by putting WML pages into the transmitted decks in advance, with time direction down,

FIG. 4 is a schematic representation illustrating the implementation using a dedicated server process for in-advance serving, with time scale down-directed,

FIG. 5 is a schematic representation illustrating a prior art communication according to the HTTP-protocol, with time scale down-directed, time direction down,

FIG. 6 is a schematic representation illustrating the traffic which develops in a sample implementation according to a preferred embodiment of the present invention—the gateway setup by a client side proxy and an In-advance Server, with time scale down-directed direction down,

FIG. 7 is a schematic representation according to FIG. 6 using servlets implementing in-advance delivery at the web server site,

FIG. 8 is a schematic representation comparing prior art and inventional server load distribution, with time scale down-directed direction down, and

FIG. 9 is a schematical representation of a probability-weighted graph representing a home page having some subordinated pages partly cross-linked with each other.

### 4. DESCRIPTION OF THE PREFERRED EMBODIMENT

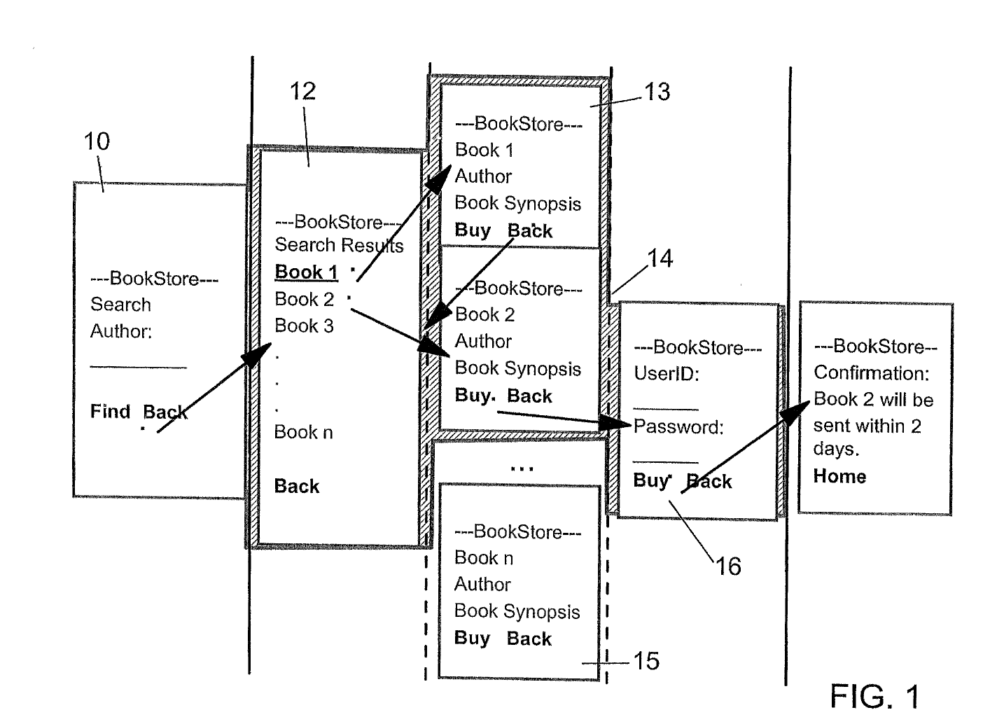

With general reference to the figures and with special reference now to FIG. 1 the method according to an embodiment of the present invention applied to a freely selected sample situation using the Internet is described in more detail next below.

In said sample situation a book-selling web site is the place where the web server performs In-advance-delivery based on WAP/WML.

Exemplarily, the following sequence is considered:

A user navigates to a first page 10 that allows to search for books written by a particular author. As a result, a list with this author's books is displayed on a second page 12. The user can select one of these books to get a synopsis page for that book. From a synopsis page, he may go back to the list or buy the book. If he chooses to buy, he gets a page where he has to enter user id and password. After confirming the purchase, he gets a delivery confirmation.

For this example, it is assumed that the consumer enters an author for whom a list of n books exists. The user selects the first book from the list to obtain a synopsis, then goes back to the list. He selects the second book in the list to obtain a synopsis and decides to buy it. He enters user id and password an gets a confirmation.

In this example, communication between the client and server is only necessary to post the author name to the server and obtain the list of his books and to post the user ID and password to the server and obtain the purchase confirmation. The list of books, on page 12 the synopsis pages 13, 14, 15 and the user ID/password form 16 may be sent on demand or in advance, together in one response, depending on the current load of the server.

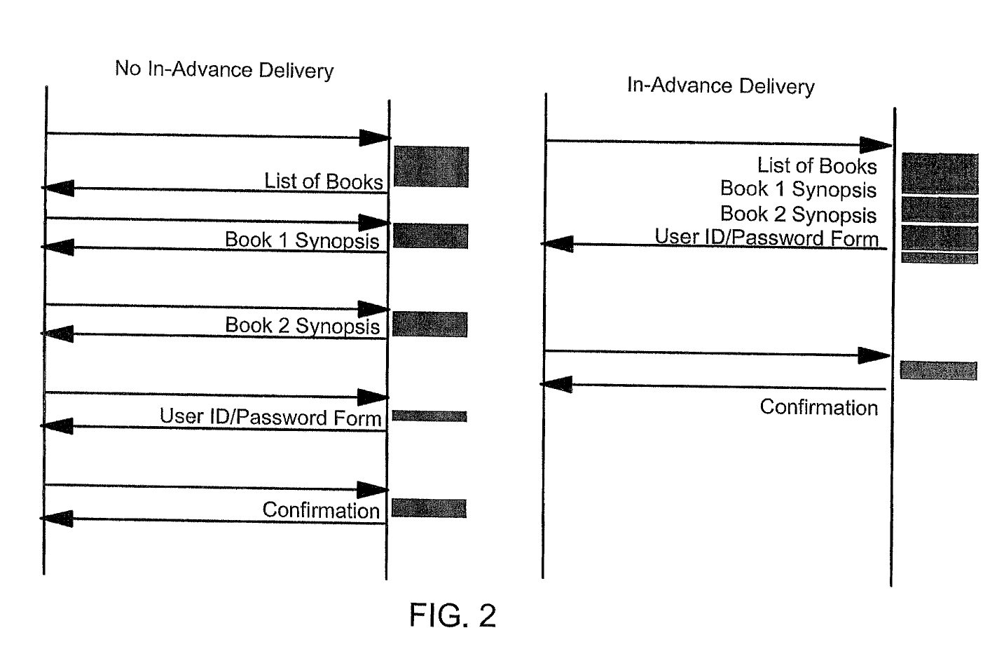

This is shown and compared to prior art (left portion) in FIG. 2:

Without in-advance content delivery according to prior art, an interaction beetween client and server looks as it is shown in the left half of FIG. 2. This option is chosen as well according to the present invention in times of high load at the server. As can be seen this is a sequence of explicit requests followed by explicit responses fulfilling the task specified in a respective request—not more.

According to the present invention with conditional in-advance content delivery, the client-server interaction looks like shown in the right half of the figure. This option is chosen by the server in times of low load. As reveals from the figure the book1 synopsis, the book2 synopsis and and the UserId/password form is sent in-advance by virtue of the present invention. Thus, the user sees the book1 synopsis while the book2 synopsis is being transmitted to the user computer's/telephone's /PDA's cache, or main memory, or into a dedicated harddisk buffer. If he decides to select book2 as mentioned above the selected synopsis is moved from the cache locally on his computer system without a separate tranmission being necessary. Thus waiting time is shortened remarkably for him.

Only the confirmation dialogue depicted last in both sides of the figutre is the same, because the purchase decision and execution cannot be predicted by any algorithm.

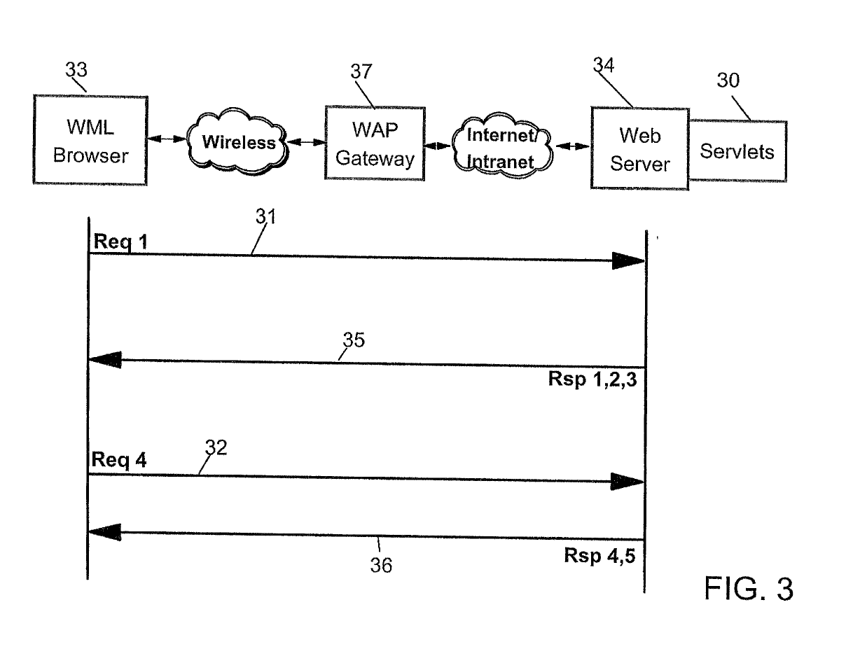

With reference now to FIG. 3 a sample implementation with WAP/WML is described next below.

The WAP standard defines the Wireless Markup Language (WML). In WML, content is delivered in so-called decks, which can consist of one or more pages. On the server side, WML content can be generated by servlets, for example. Thus, the present invention basic concepts may be implemented as follows:

1. A servlet 30 receives requests 31, 32 for delivery of content from clients represented with a WML Browser 33 via a wireless interface such as GSM, or equivalent.

2. Then the servlet 30 checks the current load on the associated server 34.

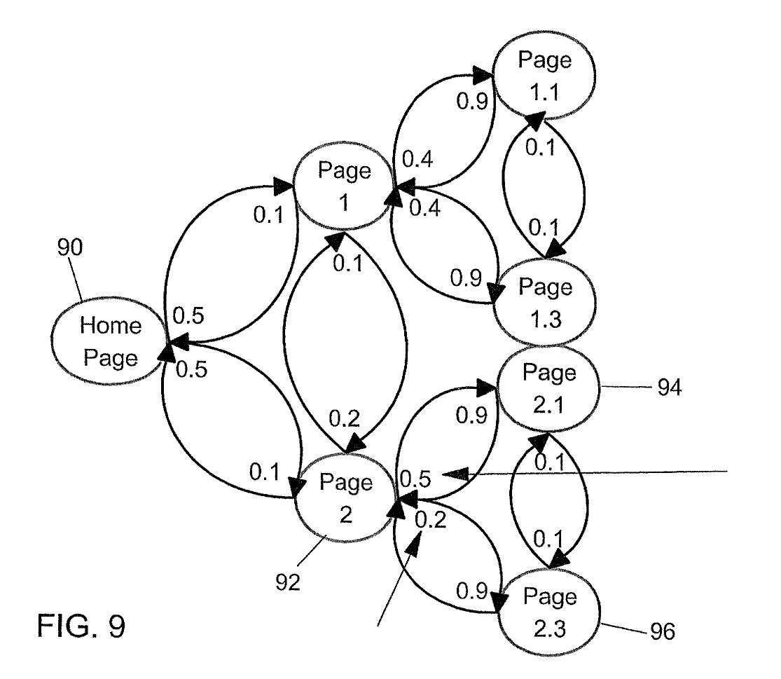

3. If the load is above a certain limit, the servlet only returns the content that was immediately requested, e.g. a deck with only one page. If, however, the load is low, the servlet resolves some of the links on the mandatory page—see the description of FIG. 9 for more details—and adds the referenced pages to the same deck. Anyhow, the servlets creates responses 35, 36 allowing an adequate user response time.

It should be added that a WAP gateway 37 is used for interconnecting from the WAP protocol to the Internet/Intranet protocol HTTP.

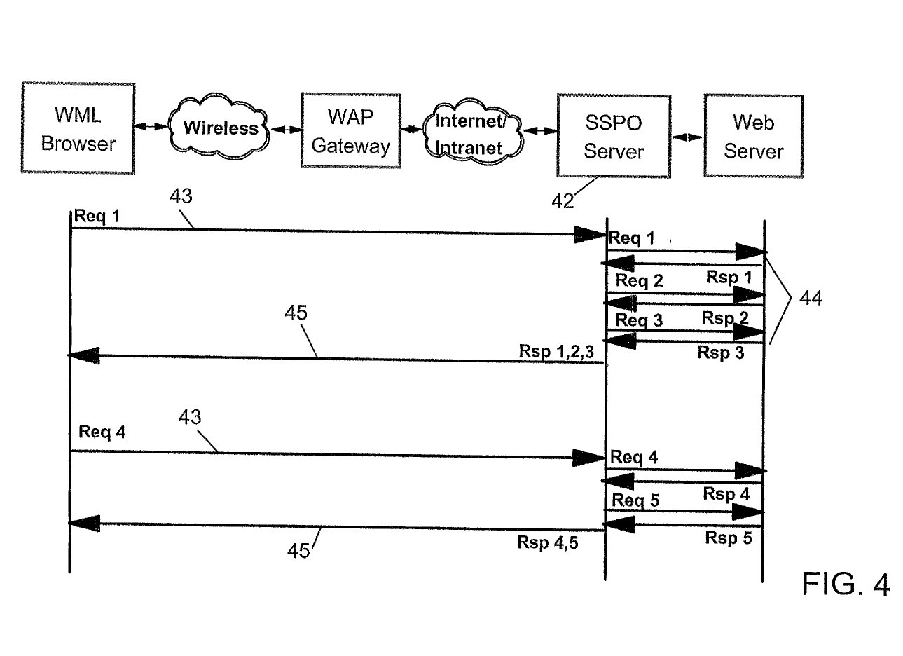

Another sample implementation is illustrated in FIG. 4. It is similar to the above one but uses a dedicated server process which cooperates with a web server 41.

4. An In-Advance or SSPO Server 42 receives an incoming request 1, 43.

5. The In-Advance Server 42 checks the current load on the server. It requests a deck 44 having a plurality of pages if the current load allows it.

6. Then the In-Advance Server 42 gets the deck 44 requested in the request.

7. If the load is low, the In-Advance Server resolves some of the links in that deck and adds the referenced pages (1,2,3) to the same deck before delivering it 45 back to the client.

In the bottom portion of FIG. 4 the same procedure is depicted with request 4 and responses 4 and 5.

The number of links to be resolved depends on the load of the server. The lower the load, the more links may be resolved and the more pages may be added to the deck. The number of links to be resolved may be computed from the server load a-priori or the servlet or server process, respectively may resolve links for a certain maximum time.

Those links which are very likely to be selected by the user are advantageously resolved first.

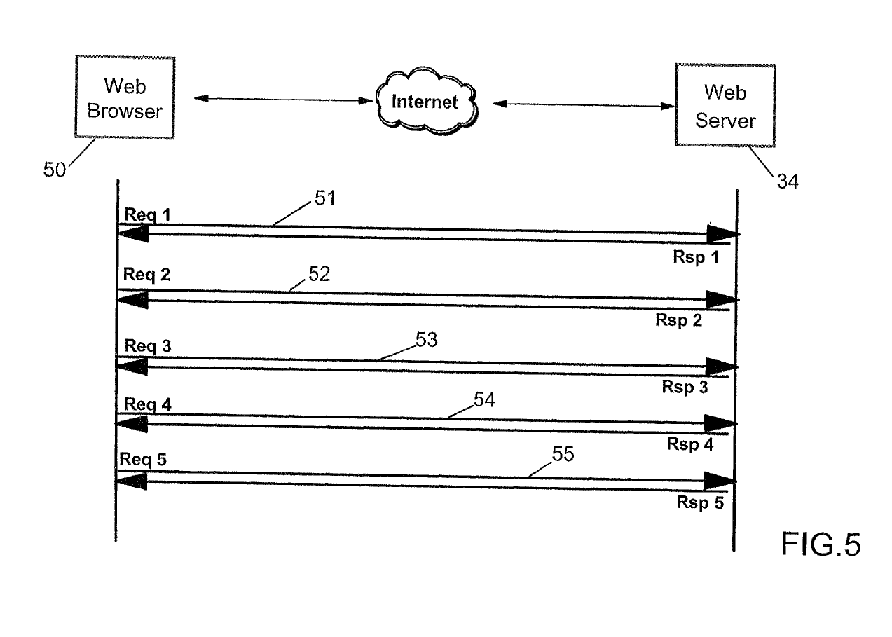

Next and with reference to FIGS. 5, 6, 7, and 8 an implementation with HTTP/HTML is described in more detail.

With HTML a special special software is required at the client side Web Browser 50, because in contrast to WML, HTML does not allow to define decks that contain several pages.

FIG. 5 shows a prior art standard HTTP communication. Whenever the user clicks on a link, the browser 50 sends resulting HTTP requests to the server 56. The server returns only content explicitly requested by the client. Thus, communication takes place in request/response pairs 51, 52, 53, 54, 55.

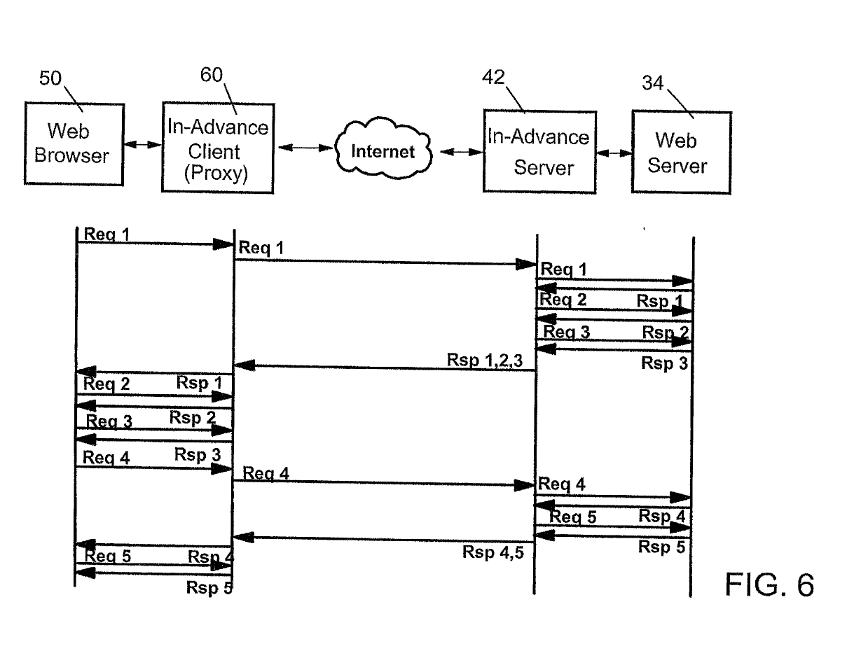

One possible implementation of Server-Side Performance Optimization is depicted in FIG. 6. It shows a client-side proxy server 60 that delivers the actually requested page to the browser 50 while storing the content which the In-advance server 42 sent in advance, in its cache.

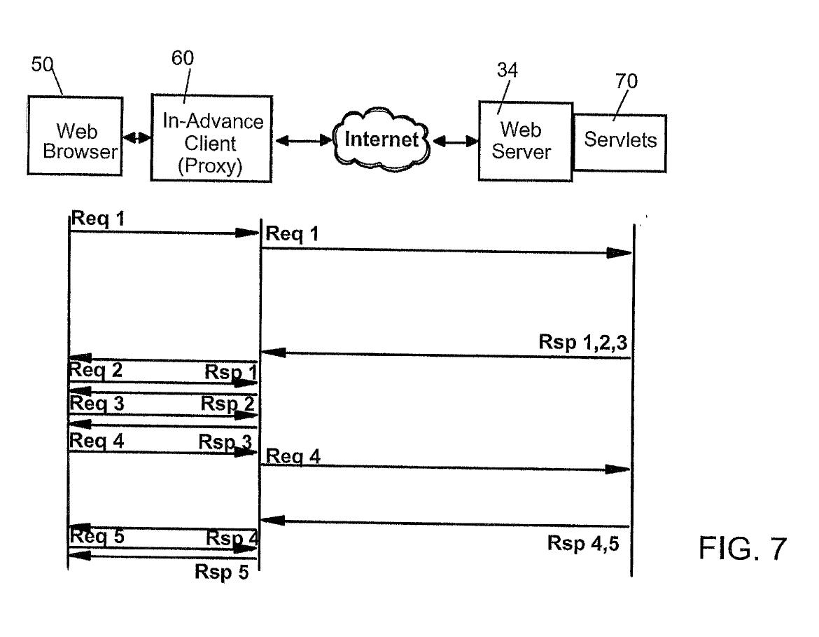

An integration of the inventional concept and mechanisms into prior art communication managing programs like the ‘WebTraffic Express Client and Server’ tool sold by IBM would be possible, according to the concept depicted in FIG. 7:

Here, servlets are used which employ the mechanism described above.

In both cases—FIG. 6, and FIG. 7, only two communications are required between client and server instead of five as it is in prior art.

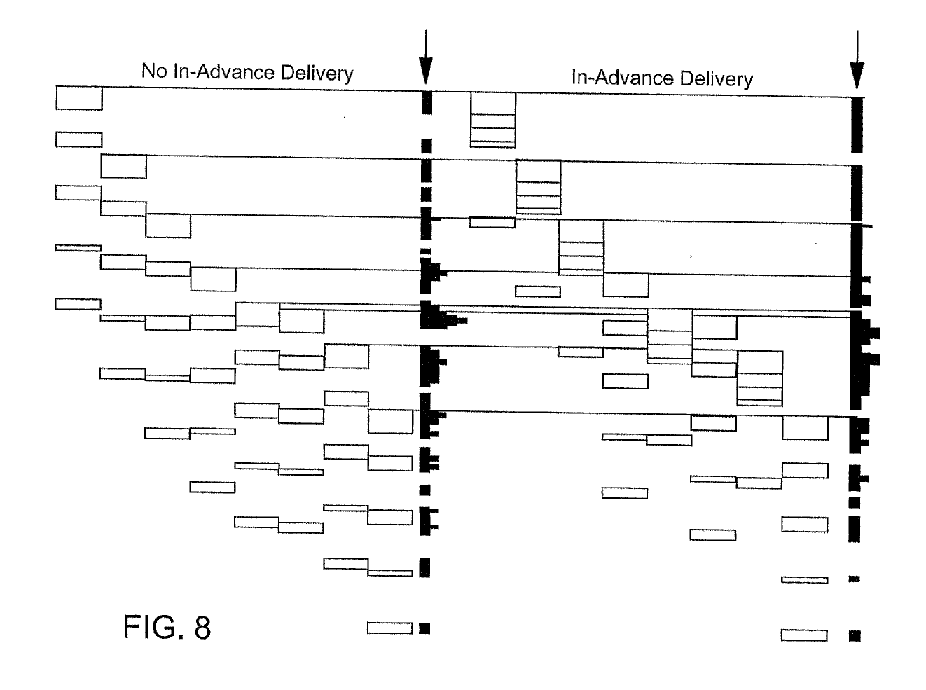

FIG. 8 illustrates the advantages achievable by the present invention. The left side represents prior art technology, the right side represents inventional concepts being applied.

The thin rectangles depict the load generated by client requests. Their vertical extent reflects the bit-extent of a request's response. The larger a rectangle the larger the number of bits transported in the network for the respective request. The solid rectangles depict the sum of the load at a particular time resulting from the plurality of responses processed at a given single point in time.

Transferring some content in advance in times where the load of the server is low helps to avoid high peeks of incoming requests in the future. Additionally, the content that has been transferred in advance reduces response times for some users.

As the server with conditional in-advance delivery already delivers some content in advance in times of low load, it avoids some future requests. In times of high load, it only delivers the required content. Thus, extreme peaks and idle times can be avoided as reveals from the curves indicated by the arrows.

The thin rectangles depict the load generated by client requests. The solid rectangles depict the sum of the loads at a particular time.

With reference now to FIG. 9 an additional aspect is described in more detail how a useful selection of subpages can be undertaken in order to achieve a good prediction of pages to be delivered in advance.

According to this preferred aspect statistics are maintained during daily traffic on a specific homepage. They are based on weighted graph calculations. The contents are represented as nodes, the links being represented as vertices, and the access probability being tracked as a vertice weight attribute. Any storage adequate when describing graph structures, for example tables are adapted to store said weight values. In the drawing said different values are printed on respective vertices, each at the bottom of a respective arrow.

Assuming now that a client requested a particular home page 90 as a basic point in time—and logic—from which the inventional concept starts to be applied.

Then he requests Page 2 92 and the current server load permits to deliver one page in advance. Then, from a plurality of two pages 2.1, and 2.3, having reference sign 94, and 96, respectively Page 2.1, 94—would be identified for in-advance delivery, since it has the higher estimated selection probability—the value of 0.5 being higher than the value of 0.2, see the arrows—in the context of Page 2.

Additionally, any estimated link selection probabilities may be provided as meta information with links in the content or they may be estimated by the server based on observed user bahavior. Thus, a good average selection can be achieved yielding a reasonable statistical success.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

It is to be understood that in particular the client computer can be any kind of computing device, a small or a more performant one, covering the whole range from a small handheld device, like a PDA, or a mobile telephone up to desktop computers, or even server serving any plurality of end-user associated desktop computers.

Further, the current usage of the server 34 might be measured in terms other than ‘instructions per second’, as might be for example, the number of active users, any absolute number of pages visited per time unit by a plurality of users, or any other criterion which is usable for the respective business situation used for said load determination.

The present invention can be realized in hardware, software, or a combination of hardware and software. A communication tool according to the present invention can be realized in a centralized fashion in one computer system, or in a distributed fashion where different elements are spread across several interconnected computer systems. This was shown above in a plurality of different situations. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following:

a) conversion to another language, code or notation;

b) reproduction in a different material form.

1. A communication method between a server and a client computing device in which responsive to client requests the requested contents are delivered from said server via a network to said client computing device, comprising the step of: in response to a current request delivering additional non-requested contents being associated with the content of the current request in predetermined traffic situations, said non-requested contents having a probability to be desired subsequently to the current request which is higher in relation to that of other contents being associated as well with the content of the current request.

2. The method according to claim 1 further comprising the step of: determining the current load of said server, delivering additional contents only when the server's current load is below a predetermined threshold level.

3. The method according to claim 2 in which said load determination comprises the step of: measuring the current usage of the server computer's processor, or the current request rate.

4. The method according to claim 3 in which the more additional contents are delivered the lower is the current server load.

5. The method according to claim 1 further comprising the step of: determining said non-requested contents from an evaluation of statistics tracking the access probability of a plurality of different contents having each an association to the currently requested content.

6. The method according to claim 5 in which said statistics are based on weighted graph calculations, the contents being represented as nodes, the linkages being represented as vertices, and the acces probability being tracked as a vertice weight attribute.

7. The method according to claim 1 further comprising the steps of: receiving transmission time information associated to particular requests, and evaluating it as a feedback information.

8. The method according to claim 1 used for delivering web pages from an Internet server computer.

9. The method according to claim 1 implemented in a programming code delivering documents described in the Wireless Markup Language (WML) to clients.

10. A server computer system having installed program means implementing means for determining and delivering non-requested contents according to the method of claim 1.

11. An intermediate server computer system switched between a server computer system according to claim 10 and a client computer system and having installed program means implementing means for receiving and buffering non-requested contents and for sequentially providing said contents to a client computer system not being able to process additional contents with a respective request.

12. A client computer system having installed program means implementing means for receiving and buffering non-requested contents delivered according to the method of claim 1.

13. A computer program for execution in a data processing system comprising computer program code portions for performing respective steps of the method according to claim 1, when said computer program code portions are executed on a computer.

14. A computer program product stored on a computer usable medium comprising computer readable program means for causing a computer to perform the method of claim 1, when said computer program product is executed on a computer.
